(19) United States
(12) Patent Application Publication
(10) Pub. No.: US 2013/0241273 A1
(43) Pub. Date: Sep. 19, 2013

(54) INTEGRATED ELECTRONIC HYDRAULIC BRAKE SYSTEM

(71) Applicant: Hyun Jun KIM, Suwon-si (KR)

(72) Inventor: Hyun Jun KIM, Suwon-si (KR)

(21) Appl. No.: 13/843,458

(22) Filed: Mar. 15, 2013

(30) Foreign Application Priority Data
Mar. 19, 2012 (KR) 10-2012-0027489

(51) Int. Cl. B60T 13/14; B60T 13/68; B60T 13/58

(52) U.S. Cl. CPC B60T 13/142; B60T 13/58; B60T 13/686
USPC 303/6.01

(57) ABSTRACT

An integrated electronic hydraulic brake system provided with an actuator including a master cylinder and a pedal simulator, an electronic stability control (ESC) and a hydraulic power unit (HPU) in a single unit.

### CROSS-REFERENCE TO RELATED APPLICATION

This application claims the benefit of Korean Patent Application No. 2012-0027489, filed on Mar. 19, 2012 in the Korean Intellectual Property Office, the disclosure of which is incorporated herein by reference.

### BACKGROUND

1. Field

Embodiments of the present invention relate to an electronic hydraulic brake system, and more particularly, to an integrated electronic hydraulic brake system which is provided with an actuator having a master cylinder and a pedal simulator, an electronic stability control (ESC) and a hydraulic power unit (HPU) in a single unit.

2. Description of the Related Art

In recent years, for the fuel efficiency and exhaust gas reduction, hybrid vehicles, fuel cell vehicles, and electric vehicles have been actively developed. Such a vehicle needs to be provided with a brake apparatus, that is, a brake apparatus of a brake system for vehicles. The brake apparatus for vehicle represents an apparatus configured to reduce the vehicle speed or to stop the vehicle while on the driving of a vehicle.

In general, the brake apparatus includes a vacuum brake generating a brake force by use of the suction pressure of an engine and a hydraulic brake generating a brake force by use of the hydraulic pressure.

The vacuum brake represents an apparatus that exhibits a large brake force by use of the pressure difference between the suction pressure of the vehicle engine and the atmospheric pressure at a vacuum booster. That is, when a driver steps a pedal, the vacuum brake generates an output significantly greater than the force applied to the pedal by a driver.

In order for the vacuum brake to form vacuum, a suction pressure of the engine of the vehicle needs to be provided to a vacuum booster, causing the fuel efficiency to be reduced. In addition, in order to form vacuum at the time of stopping the vehicle, the engine needs to be driven at all times.

In addition, since the fuel cell vehicle and the electric vehicle are not provided with engines, the general vacuum brake that amplifies the pedal effort between the brake operations is difficult to be applied to the fuel cell vehicle and the electric vehicle, and since the hybrid vehicle needs to be equipped with an idle stop function to enhance the fuel efficiency, the hydraulic brake is required.

That is, all the vehicles described above needs to implement the regenerative brake operation to enhance the fuel efficiency, and the hydraulic brake easily enables the regenerative braking operation.

Meanwhile, an electronic hydraulic brake system classified into the hydraulic brake is a brake system in which a driver steps a pedal and an electronic control unit senses the stepping on the pedal and supplies a fluid pressure to a master cylinder, and thus the brake fluid pressure to wheel cylinders (not shown) on respective wheels so as to generate a brake force.

Referring to FIG. 1, the electronic hydraulic brake system includes an actuator 1 including a master cylinder 1a to control the brake fluid pressure being delivered to a wheel cylinder 20, a boosted b, a reservoir 1c and a pedal simulator 1d, an electronic stability control (ESC) 2 individually controlling the respective wheels, and a hydraulic power unit (HPU) 3 including a motor, a pump, an accumulator and a control valve.

However, the respective units forming the electronic hydraulic brake system are separately provided and installed from each other, a large installation space needs to be ensured due to the limitation on the installation space in the vehicle, and also the weight of the vehicle is increased. In this regard, there is a need for an electronic hydraulic brake system capable of ensuring the vehicle stability at the braking operation, enhancing the fuel efficiency and the proper stepping operation while improving the braking performance.

In addition, the pedal simulator 1d is an apparatus that receives a pressure generated by the food effort of a brake pedal (not shown) to press a piston (not shown) and a spring (not shown) that are provided at an inside a simulation chamber (not shown) so as to provide a stepping operation according to the reaction to the compression of the spring. Such a conventional pedal simulator 1d is provided as a dry type. The dry type is implemented as a pneumatic structure including a simulation chamber having a piston and a spring exposed to the air. Accordingly, the movement of piston causes a friction and a long period of time of use of the pedal simulator reduces the durability and increases the possibility for foreign substance to be introduced.

Accordingly, a large amount of researches is conducted to develop an electronic hydraulic brake system provided with a simple configuration, ensuring an easy control, facilitating implementing a brake force even at a malfunction, improving the durability of a pedal simulator and preventing foreign substances from being introduced.

### SUMMARY

Therefore, it is an aspect of the present invention to provide an integrated electronic hydraulic brake system having a simple configuration thereof so as to improve the safety on the braking operation and the installation efficiency on the vehicle, and providing a stable stepping operation while enhancing the fuel efficiency by supporting the regenerative brake.

Additional aspects of the invention will be set forth in part in the description which follows and, in part, will be obvious from the description, or may be learned by practice of the invention.

In accordance with one aspect of the present invention, an integrated electronic hydraulic brake system for vehicles includes an integrated hydraulic control device and a power source unit. The integrated hydraulic control device may include a master cylinder, two hydraulic circuits, an accumulator, a flow control valve and a pressure reducing valve, a pedal simulator, and a simulation valve. The master cylinder may be configured to generate a fluid pressure by a pedal effort of a brake pedal. The reservoir may be coupled to an upper part of the master cylinder so as to store oil. The two hydraulic circuits each may be connected to two wheels. The accumulator may be configured to store a predetermined level of pressure. The flow control valve and the pressure reducing valve may be connected to each of the two hydraulic circuits so as to control a pressure being transmitted from the accumulator to wheel cylinders installed on the respective wheels. The pedal simulator may be connected to the master cylinder to provide a reaction force of the brake pedal. The simulation valve may be installed on a path connecting the pedal simulator to the reservoir. The power source unit may include a pump to draw the oil from the reservoir and discharge the drawn oil to the accumulator to form a pressure at the accumulator, and a motor to drive the pump. The power source unit may be provided as a separate unit from the integrated hydraulic control device so as to separate operating noise, and the integrated hydraulic control device may be connected to the power source unit through an external pipe. The pedal simulator may be configured to fill oil therein through the simulation valve.

The integrated electronic hydraulic brake system may further include a simulation check valve provided between the pedal simulator and the simulation valve. A pressure at a rear end of the pedal simulator according to the pedal effort of the brake pedal may be transmitted only through the simulation valve, and at the time of releasing of the pedal effort of the brake pedal, oil may be drawn to the pedal simulator through the simulation check valve and stored.

The external pipe may connect the accumulator to the pump, and a check valve may be installed to prevent the pressure of the accumulator from flowing backward.

The check valve may be a pipe-purpose check valve having no spring.

The integrated hydraulic control device may further include a first backup path and a second backup path, and a first shut off valve and a second shut off valve. The first backup path and the second backup path may connect the master cylinder to the two hydraulic circuits so as to control a brake oil when the integrated electronic hydraulic brake system abnormally operates. The first shut off valve may be configured to control a connection between the first backup path and the master cylinder, and a second shut off valve may be configured to control a connection between the second backup path and the master cylinder.

Each of the first shut off valve and the second shut off valve may be provided as a normally open type solenoid valve that is maintained in an open state at normal times, and at the time of a normal braking, is operated to be closed.

Each of the hydraulic circuits may include a normally open type solenoid valve, a normally closed type solenoid valve and a return valve. The normally open type solenoid valve may be disposed at a upstream side of the wheel cylinder to control a fluid pressure being transmitted to the wheel cylinder. The normally closed type solenoid valve may be disposed at a downstream side of the wheel cylinder to control a fluid pressure being discharged from the wheel cylinder. The return path may connect the normally closed type solenoid valve to the reservoir.

A pulsation attenuation device configured to minimize a pressure pulsation may be formed on a path connecting the fluid control valve and the pressure reducing valve to each of the two hydraulic circuits.

Each of the flow control valve and the pressure reducing valve may be provided in a normally closed type solenoid valve that is maintained in a closed state at normal times.

As described above, the integrated electronic hydraulic brake system is incorporated with the power source unit, which includes the motor and the pump, and an integrated hydraulic control device, which includes a simulator configured to form a pedal effort of a brake pedal in cooperation with the accumulator and various valves and sensors, in the form of a single block, thereby easily securing the installation space while facilitating the assembly operation.

In addition, a pedal simulator is connected to a reservoir, and a simulation valve to control the connection is provided, and oil is stored at an inside the pedal simulator so that the durability of the pedal simulator is improved while preventing the external foreign substances from being introduced into the pedal simulator. In addition, a simulation check valve having no spring is provided, so that the residual pressure is minimized, and even if the pressure at the braking operation is randomly adjusted, the stepping action being transmitted to a driver is stably maintained.

In addition, the braking operation of the vehicle is provided even at the malfunction of the brake system, and thus the application to electric vehicles, fuel cell vehicles and hybrid vehicles is easily achieved.

In addition, a brake force desired by a driver is implemented regardless of the existence or the operation of an engine, so that the fuel efficiency is enhanced.

In addition, when compared to a conventional negative pressure type booster, the integrated electronic hydraulic brake system in accordance with the present disclosure has a simple configuration. Different from a vacuum brake, the suction pressure of the engine is not used, so that the fuel efficiency of the vehicles is enhanced. Such a simple configuration of the electronic hydraulic brake system enables the application to a compact size vehicle.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view schematically illustrating a conventional electronic hydraulic brake system;

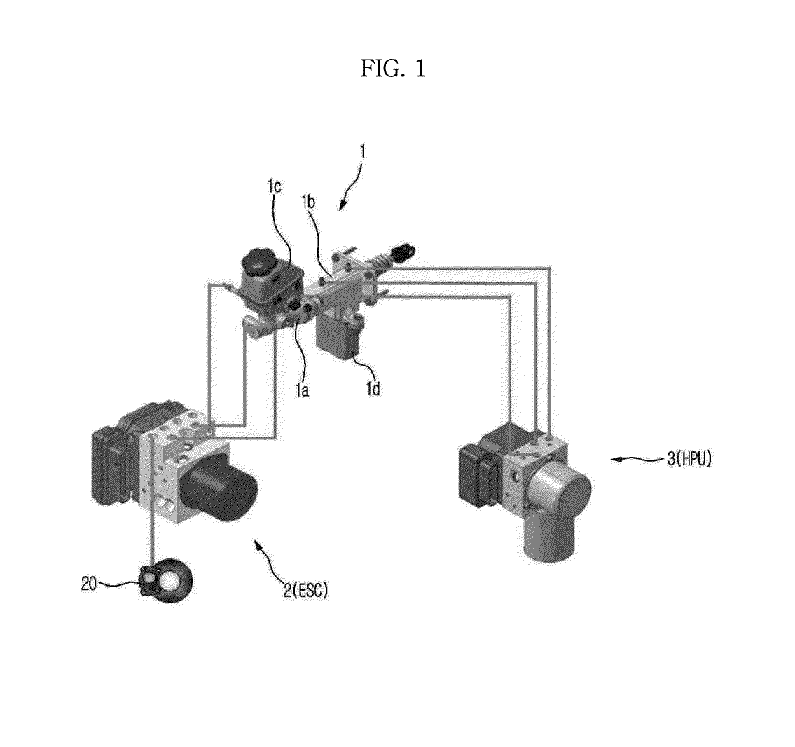

FIG. 2 is a hydraulic circuit diagram of an integrated electronic hydraulic brake system in accordance with one embodiment of the present disclosure at a non-braking operation;

FIG. 3 is a hydraulic circuit diagram of an integrated electronic hydraulic brake system in accordance with one embodiment of the present disclosure at a normal operation; and

FIG. 4 is a hydraulic circuit diagram of an integrated electronic hydraulic brake system in accordance with one embodiment of the present disclosure at an abnormal operation.

### DETAILED DESCRIPTION

Reference will now be made in detail to the embodiments of the present invention, examples of which are illustrated in the accompanying drawings, wherein like reference numerals refer to like elements throughout.

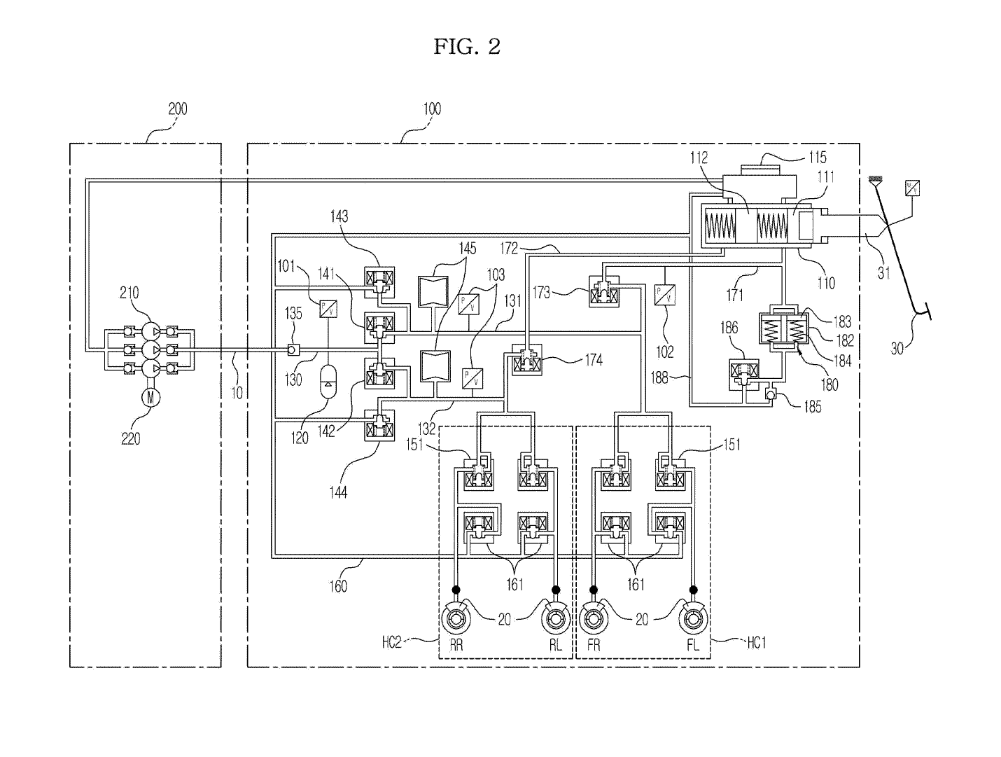

FIG. 2 is a hydraulic circuit diagram of an integrated electronic hydraulic brake system in accordance with one embodiment of the present disclosure.

An integrated electronic hydraulic brake system in accordance with an embodiment of the present disclosure is mainly divided into two units. Referring to FIG. 2, the integrated electronic hydraulic brake system includes an integrated hydraulic control device 100 including a brake pedal 30 manipulated by a driver at a braking operation, a master cylinder 110 to which the force is transmitted from the brake pedal 30, a reservoir 115 coupled to an upper part of the master cylinder 110 so as to store oil, two hydraulic circuits HC1 and HC2 each connected to two of wheels RR, RL, RF and FL, an accumulator 120 to store a predetermined level of pressure, a pedal simulator 180 connected to the master cylinder 110 to provide a reaction force of the brake pedal 30, and a simulation valve 186 installed on a path 188 connecting the pedal simulator 180 to the reservoir 115; and a power source unit 200 including a pump 210 to draw the oil from the reservoir 115 and discharge the drawn oil to the accumulator 120 to form a pressure at the accumulator 120, and a motor 220 to drive the pump 210.

In addition, the integrated hydraulic control device 100 may further include flow control valves 141 and 142 and pressure reducing valves 143 and 144 that are connected to two hydraulic circuits HC1 and HC2 so as to control a pressure being transmitted to the wheel cylinder 20 installed at each of the wheels FL, FR, RL and RR from the accumulator 120, and pressure sensors 101, 102 and 103.

In this case, the integrated hydraulic control device 100 and the power source unit 200 are connected to each other through an external pipe 10. That is, the pump 210 of the power source unit 200 is connected to the accumulator 120 of the integrated hydraulic control device 100 through the external pipe 10. By forming the power source unit 200 including the pump 210 and the motor 220 in a separate unit, the operating noise is separated. In addition, the integrated hydraulic control device 100 has the master cylinder 110, the reservoir 115 and the pedal simulator 180 grouped in a single entity, while being incorporated with the functions of an electronic stability control (ESC) and a hydraulic power unit (HPU), so that the weight of the integrated electronic hydraulic brake system is reduced and the installation space is secured.

Hereinafter, the configuration and the function of each component forming the integrated electronic hydraulic brake system will be described in detail. First, the master cylinder 110 may be formed by at least one chamber to generate a fluid pressure, and is illustrated as being formed by two chambers in which a first piston 111 and a second piston 112 are formed, respectively. The master cylinder 110 is configured to generate a fluid pressure according to the pedal effort of the brake pedal 30, and the chambers are connected to the two hydraulic circuits HC1 and HC2, respectively.

Since the master cylinder 110 is provided with the two chambers which are connected to the two hydraulic circuits HC1 and HC2, the operation safety is secured at a malfunction. In general, as shown on the drawing, a first hydraulic circuit HC1 between the two hydraulic circuits HC1 and HC2 is connected to two front wheels FL and FR, and a second hydraulic circuit HC2 between the two hydraulic circuits HC1 and HC2 is connected to two rear wheels RL and RR. Alternatively, a first hydraulic circuit HC1 between the two hydraulic circuits HC1 and HC2 may be connected to the front right wheel FR and the rear left wheel RL, and a second hydraulic circuit HC2 between the two hydraulic circuits HC1 and HC2 may be connected to the front left wheel FL and the rear right wheel RR. As described, the two hydraulic circuits HC1 and HC2 are configured independent of each other, and even if one of the hydraulic circuits HC1 and HC2 is broken, the braking for vehicles may be possible.

The master cylinder 110 is provided at an upper side with the reservoir 115, and at a lower side with an exit allowing oil to be discharged to the wheel cylinder 20 installed on each of the wheels RR, RL, FR, and FL.

Meanwhile, each of the hydraulic circuits HC1 and HC2 includes a path connecting to the wheel cylinder 20, and a plurality of valves 151 and 161 is provided on the path to control the fluid pressure. As shown on the drawing, the plurality of valves 151 and 161 is divided into a normally open type (hereinafter, referred to as a NO type) solenoid valve 151 disposed at an upstream side of the wheel cylinder 20 to control the fluid pressure being transmitted to the wheel cylinder, and a normally closed type (hereinafter, referred to as a NC type) solenoid valve 161 disposed at a downstream side of the wheel cylinder 20 to control the fluid pressure being discharged from the wheel cylinder 20. The opening/closing operation of the solenoid valves 151 and 161 is controlled by an electronic control unit (not shown) that is generally known in the art.

In addition, each of the hydraulic circuits HC1 and HC2 includes a return path 160 connecting the NC type solenoid valve 161 to the reservoir 115. The return path 160 is configured to discharge the fluid pressure being transmitted to the wheel cylinder 20 such that the fluid pressure is transmitted to the reservoir 115.

Meanwhile, reference numeral ‘31’ represents an input load installed on the brake pedal 30 so as to transmit a pedal effort to the master cylinder 110.

The pump 210 is provided in at least one unit thereof so as to pump the oil being introduced from the reservoir 115 at high pressure, thereby forming a brake pressure. The motor 220 is provided at one side of the pump 210 to provide the pump 210 with a driving force. The motor 220 is driven by receiving the desire of a driver for a braking operation according to the pedal effort from a second pressure sensor 102 or a pedal displacement sensor that is to be described later.

The accumulator 120 is provided at an exit side of the pump 210 to temporarily store oil of a high pressure that is generated by the pump 210 driven. That is, as described above, the accumulator 120 is connected to the pump 210 through the external pipe 10. In this case, a check valve 135 is installed on the external pipe 10 to prevent the oil stored in the accumulator 120 from being flown backward.

A first pressure sensor 101 is provided at an exit side of the accumulator 120 to measure the oil pressure of the accumulator 120. In this case, the oil pressure measured by the first pressure sensor 101 is compared with a predetermined pressure that is set by the electronic control unit (not shown), and the pump 210 is driven if the measured oil pressure is lower than the predetermined oil pressure, so that the oil in the reservoir 115 is drawn to be filled in the accumulator 120.

In order to transmit the brake oil stored in the accumulator 120 by the operation of the pump 210 and motor 220 to the wheel cylinder 20, a connection path 130 connecting to the external pipe 10 is provided, and the connection path 130 is connected to a first inlet path 131 connected to the first hydraulic circuit HC1 and a second inlet path 132 connected to the second hydraulic circuit HC2. A first flow control valve 141 and a first pressure reducing valve 143 are provided on the first inlet path 131, which is connected to the connection path 130, so as to control the brake oil stored in the accumulator 120, and a second flow control valve 142 and a second pressure reducing valve 144 are provided on the second inlet path 132, which is connected to the connection path 130, so as to control the brake oil stored in the accumulator 120. That is, the brake oil of the accumulator 120 is transmitted to each wheel cylinder 20 by the first inlet path 131 and the second inlet path 132.

Each of the first and second flow control valves 141 and 142 and the first and second pressure reducing valves 143 and 144 is provided as a normally close type solenoid valve that is maintained in a closed state at normal times. Accordingly, if a driver steps the brake pedal 30, the first flow control valve 141 and the second flow control valve 142 are open, and then the brake oil stored in the accumulator 120 is transmitted to the wheel cylinder 20.

The integrated hydraulic control device 100 may further include a pulsation attenuation device 145 provided at each of the first inlet path 131 and the second inlet path 132 to minimize the pressure pulsation. The pulsation attenuation device 145 is designed to temporarily store oil so as to attenuate the pulsation generated among the flow control valves 141 and 142, the pressure reducing valves 143 and 144 and the NO type solenoid valve 151. The pulsation attenuation device is generally known in the art, and thus the detailed description thereof will be omitted.

Reference numerals 103 represent a pressure sensor that is installed on the first inlet path 131 and the second inlet path 132 to sense the pressure of the brake fluid pressure being transmitted to the inlet paths 131 and 132. Accordingly, the pulsation attenuation device 145 may be controlled to lower the pulsation according to the pressure of the brake oil being sensed by the pressure sensor.

In accordance with the present disclosure, a first backup path 171 and a second backup path 172 are provided that connect the master cylinder 110 to the two hydraulic circuits HC1 and HC2 when the integrated electronic hydraulic brake system is broken. A first shut off valve 173 is provided on the first backup path 171 to open and close the first backup path 171, and a second shut off valve 174 is provided on the second backup path 172 to open and close the second backup path 172. The first backup path 171 is connected to the first inlet path 131 through the first shut off valve 173, and the second backup path 172 is connected to the second inlet path 132 through the second shut off valve 174. In particular, the second pressure sensor 102 is provided between the first shut off valve 173 and the master cylinder 110 to measure the oil pressure of the master cylinder 110. Through such, at a normal braking operation, the backup paths 171 and 172 are blocked by the first shut off valve 173 and the second shut off valve 174, and the desire of a driver for a braking operation is determined by the second pressure sensor 102.

Each of the first and second shut off valves 173 and 174 is provided in the form of a NO type solenoid valve that is maintained in an open state at normal times, and during a normal braking operation, is closed.

In accordance with the present disclosure, the pedal simulator 180 is provided between the second pressure sensor 102 and the master cylinder 110 to form a pedal effort of the brake pedal 30.

The pedal simulator 180 includes a simulation chamber 182 provided to store oil being discharged from the exit side of the master cylinder 110, and a simulation valve 186 connected to a rear end of the simulation chamber 182. The simulation chamber 182 includes a piston 183 and an elastic member 184 so as to form a predetermined range of displacement by the oil being introduced to the simulation chamber 182.

The simulation valve 186 is installed on the path 188 that connects the rear end of the pedal simulator 180 to the reservoir 115. As shown on the drawing, an entry of the pedal simulator 180 is connected to the master cylinder 110, the simulator valve 186 is mounted at the rear end of the pedal simulator 180, and an exit of the simulation valve 186 is connected to the reservoir 115, so that pedal simulator 180, that is, the interior space of the simulation chamber 182 is fully filled with oil.

The simulation valve 186 is provided in the form of a normally close type solenoid valve that is maintained in a closed state at normal times, and when a driver steps the brake pedal 30, the simulation valve 186 is open.

In addition, a simulation check valve 185 is provided between the pedal simulator 180 and the master cylinder 110, that is, between the pedal simulator 180 and the simulation valve 196, and the simulation check valve 185 is configured to allow the oil to flow from the reservoir 115 to the simulation chamber 182. The simulation check valve 185 is configured to allow the pressure at the rear end of the pedal simulator 180 according to the pedal effort of the brake pedal 30 to be transmitted only through the simulation valve 186. That is, the piston 183 of the pedal simulator 180 compresses the spring 184, and the oil in the simulation chamber 182 is transmitted to the reservoir 115 through the simulation valve 186 and the path 188. At this time, oil is filled in the simulation chamber 182, so the friction of the piston 183 is minimized at the operation of the pedal simulator 180, and the durability of the pedal simulator 180 is improved, thereby providing a structure preventing the foreign substance from being introduced thereinto.

In addition, at the time of releasing the pedal effort of the brake pedal 30, oil is supplied to the simulation chamber 182 through the simulation check valve 185, and thus the return of the pressure of the pedal simulator 180 is achieved in a rapid manner. The simulation check valve 185 may be provided as a pipe-purpose check valve having no spring, so that the residual pressure of the pedal simulator 180 is returned at the time of releasing the pedal effort of the brake pedal 30.

The integrated hydraulic control device 100 is provided as a single block including an electronic control unit (ECU) that is electrically connected to the respective valves and sensors, thereby leading to the compactness of the integrated electronic hydraulic brake system. That is, the integrated electronic hydraulic brake system in accordance with the present disclosure is provided with the power source unit 200, which includes the motor 220 and the pump 210, and the pedal simulator 180 configured to form a pedal effort of the brake pedal 30 in cooperation with the accumulator 120, and various valves and sensors, in the form of a single block, thereby easily securing the installation space while decreasing the weight thereof.

Hereinafter, the operation of the integrated electronic hydraulic brake system in accordance with an embodiment of the present disclosure will be described in detail.

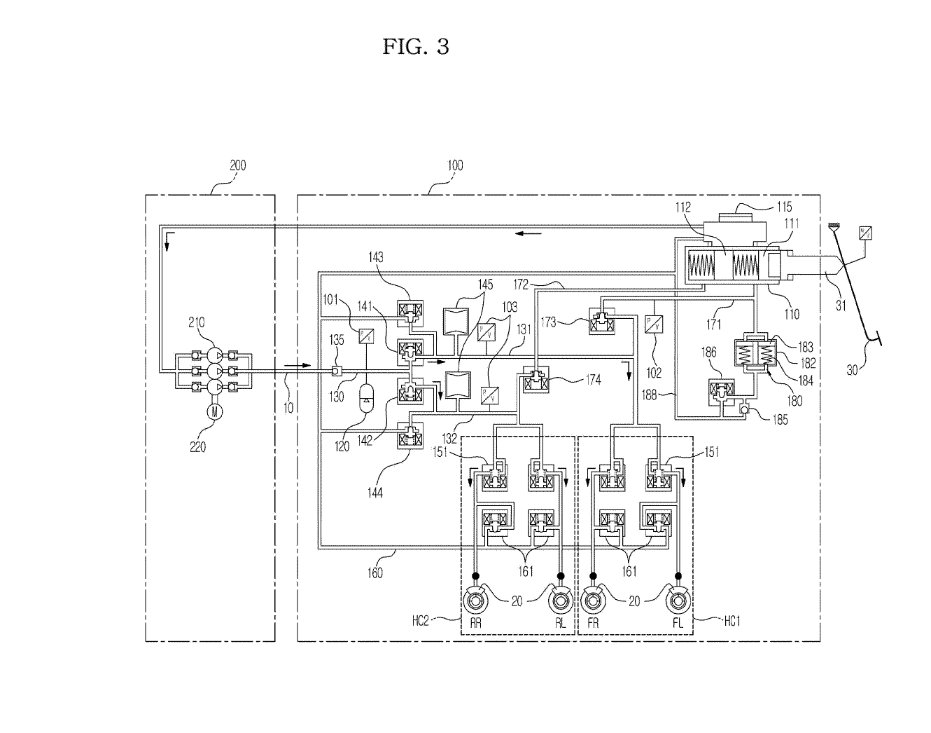

FIG. 3 is a hydraulic circuit diagram of an integrated electronic hydraulic brake system in accordance with one embodiment of the present disclosure at a normal operation.

Referring to FIG. 3, when a driver starts the brake operation, the amount of desired brake operation of a driver is sensed through the pressure information of the brake pedal 30 stepped by the driver through the second pressure sensor 102 or a pedal displacement sensor. The electronic control unit (not shown) may receive the magnitude of the amount of regenerative brake, and the magnitude of the amount of friction brake is calculated according to the difference between the amount of desired brake operation and the amount of regenerative brake operation, thereby determining the magnitude of the increase or decrease of the pressure at the wheel side.

In detail, in the beginning of the braking operation, if a driver steps the brake pedal 30, the braking operation is sufficiently achieved by the regenerative brake, and thus a control is made to prevent the friction brake from occurring. Accordingly, a pressure reduction of brake oil is required so as to prevent the fluid pressure, which is generated at the master cylinder 110 after being transmitted from the brake pedal 30, from being transmitted to the wheel cylinder 20. In this case, by opening the pressure reducing valves 143 and 144 so that the fluid pressure formed at the inlet paths 131 and 132 is discharged to the reservoir 115 so as to prevent pressure from being formed at the wheels RR, RL, FR, and FL while maintaining the pressure of the brake pedal.

Thereafter, a process of adjusting the amount of friction brake according to the change in the regenerative brake is performed. The amount of regenerative brake varies with the charging status of a battery or the vehicle speed. If the vehicle speed is below a predetermined speed, the amount of the regenerative brake is rapidly decreased. In order to cope with such a condition, the first flow control valve 141 may control the flow rate of the brake oil being transmitted from the accumulator 120 to the first inlet path 131, and the second flow control valve 142 may control the flow rate of the brake oil being transmitted from the accumulator 120 to the second inlet path 142.

Thereafter, the amount of regenerative brake is not present, so the braking operation is performed according to a general brake condition.

Meanwhile, the pressure generated by the pressing of the master cylinder 110 according to the pedal effort of the brake pedal 30 is transmitted to the pedal simulator 180 connected to the master cylinder 110. In this case, the simulation valve 186 installed on the path 188 connecting the rear end of the pedal simulator 180 to the reservoir 115 is operated to be open, so that the oil filled in the simulation chamber 182 is transmitted to the reservoir 115 through the simulation valve 186. In addition, the pressure corresponding to the piston 183 and the spring 184 supporting the piston 183 may provide the driver with a proper stepping sensation through the simulation chamber 182. In addition, at the time of releasing the pedal effort of the brake pedal 30, the oil is refilled into the simulation chamber 182 through the simulation check valve 185, thereby ensuring the return of pressure of the pedal simulator 180 in a rapid manner.

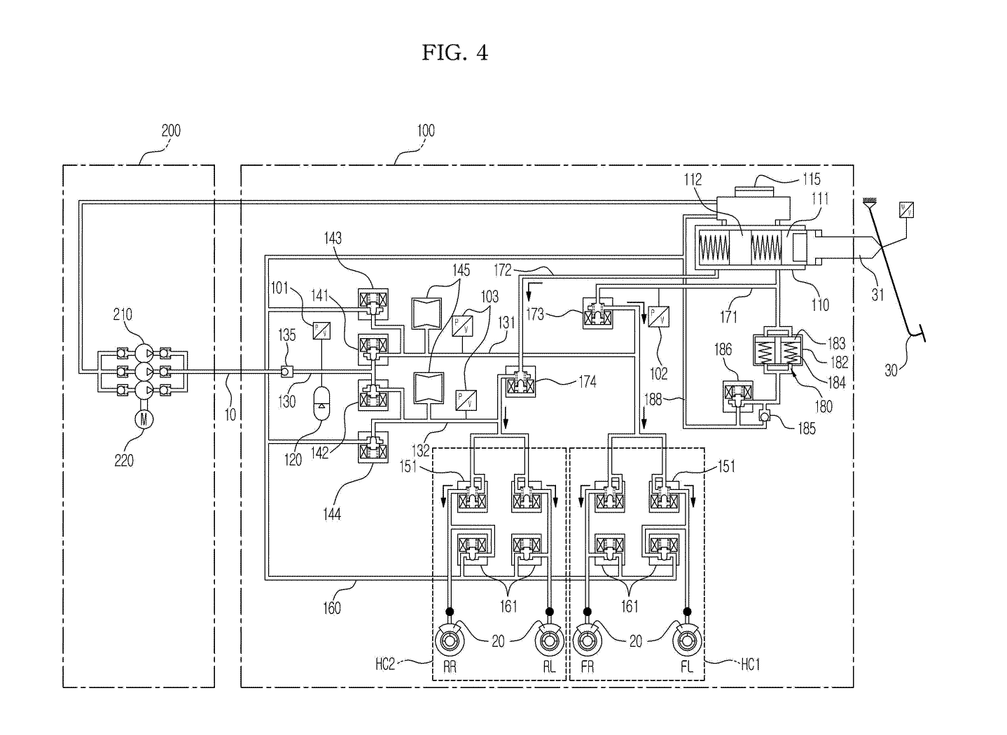

FIG. 4 is a hydraulic circuit diagram of an integrated electronic hydraulic brake system in accordance with one embodiment of the present disclosure at an abnormal operation.

Referring to FIG. 4, when the integrated electronic hydraulic brake system is not normally operated, the pressure is transmitted through the first backup path 171 and the second backup path 172 to the wheel cylinder 20, thereby implementing the brake force. In this case, each of the first shut off valve 173 and the second shut off valve 174, which are installed on the first backup path 171 and the second backup path 172, and the solenoid valve 151 of the two hydraulic circuits HC1 and HC2 is provided as a normally open type solenoid valve, and each of the first flow control valve 141, the second flow control valve 142, the first pressure reducing valve 143 and the second pressure reducing valve 144 is provided as a normally close type solenoid valve, so that the fluid pressure is directly transmitted to the wheel cylinder 20. Accordingly, a stable braking is achieved, thereby improving the safety on the brake operation.

Meanwhile, the master cylinder 110 has a reduced inner circumference when compared to a general master cylinder so as to maximize the mechanical braking performance according to the pedal effort of the brake pedal 30. That is, the master cylinder 110 has an inner circumference smaller than that of a general master cylinder, but may exit a sufficient brake force through the brake oil stored in the reduced inner circumference.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An integrated electronic hydraulic brake system for vehicles comprising:
an integrated hydraulic control device comprising a master cylinder to generate a fluid pressure by a pedal effort of a brake pedal, a reservoir coupled to an upper part of the master cylinder so as to store oil, two hydraulic circuits each connected to two wheels, an accumulator to store a predetermined level of pressure, a flow control valve and a pressure reducing valve that are connected to each of the two hydraulic circuits so as to control a pressure being transmitted from the accumulator to wheel cylinders installed on the respective wheels, a pedal simulator connected to the master cylinder to provide a reaction force of the brake pedal, and a simulation valve installed on a path connecting the pedal simulator to the reservoir; and
a power source unit comprising a pump to draw the oil from the reservoir and discharge the drawn oil to the accumulator to form a pressure at the accumulator, and a motor to drive the pump,
wherein the power source unit is provided as a separate unit from the integrated hydraulic control device so as to separate operating noise, and the integrated hydraulic control device is connected to the power source unit through an external pipe, and
wherein the pedal simulator is configured to fill oil therein through the simulation valve.

2. The integrated electronic hydraulic brake system for vehicles of claim 1, further comprising a simulation check valve provided between the pedal simulator and the simulation valve, wherein a pressure at a rear end of the pedal simulator according to the pedal effort of the brake pedal is transmitted only through the simulation valve, and at the time of releasing of the pedal effort of the brake pedal, oil is drawn to the pedal simulator through the simulation check valve and stored.

3. The integrated electronic hydraulic brake system for vehicles of claim 1, wherein the external pipe connects the accumulator to the pump, and a check valve is installed to prevent the pressure of the accumulator from flowing backward.

4. The integrated electronic hydraulic brake system for vehicles of claim 2 or claim 3, wherein the check valve is a pipe-purpose check valve having no spring.

5. The integrated electronic hydraulic brake system for vehicles of claim 1, wherein the integrated hydraulic control device further comprises:
a first backup path and a second backup path that connect the master cylinder to the two hydraulic circuits so as to control a brake oil when the integrated electronic hydraulic brake system abnormally operates; and a first shut off valve to control a connection between the first backup path and the master cylinder and a second shut off valve to control a connection between the second backup path and the master cylinder.

6. The integrated electronic hydraulic brake system for vehicles of claim 5, wherein each of the first shut off valve and the second shut off valve is provided as a normally open type solenoid valve that is maintained in an open state at normal times, and at the time of a normal braking, is operated to be closed.

7. The integrated electronic hydraulic brake system for vehicles of claim 1, wherein each of the hydraulic circuits comprises:
a normally open type solenoid valve disposed at a upstream side of the wheel cylinder to control a fluid pressure being transmitted to the wheel cylinder;
a normally closed type solenoid valve disposed at a downstream side of the wheel cylinder to control a fluid pressure being discharged from the wheel cylinder; and
a return path connecting the normally closed type solenoid valve to the reservoir.

8. The integrated electronic hydraulic brake system for vehicles of claim 1, wherein a pulsation attenuation device configured to minimize a pressure pulsation is formed on a path connecting the fluid control valve and the pressure reducing valve to each of the two hydraulic circuits.

9. The integrated electronic hydraulic brake system for vehicles of claim 8, wherein each of the flow control valve and the pressure reducing valve is provided in a normally closed type solenoid valve that is maintained in a closed state at normal times.
